(19) United States
(12) Patent Application Publication
(10) Pub. No.: US 2019/0316554 A1
(43) Pub. Date: Oct. 17, 2019

(54) FUEL SYSTEM FOR AN INTERNAL COMBUSTION ENGINE

(71) Applicant: Scania CV AB, Södertälje (SE)

(72) Inventors: Adam BERG, Nyköping (SE); Kim KYLSTRÖM, Tullinge (SE); Emil KYLBERG, Bromma (SE); Patrik FOGELBERG, Huddinge (SE)

(73) Assignee: Scania CV AB, Södertälje (SE)

(21) Appl. No.: 16/317,468

(22) PCT Filed: Jul. 17, 2017
(86) PCT No.: PCT/SE2017/050787

§ 371 Date: Jan. 11, 2019

(30) Foreign Application Priority Data
Jul. 18, 2016 (SE) 1651070-3

(51) Int. Cl. F02M 37/18; F02D 41/30

(52) U.S. Cl. CPC F02M 37/18; F02D 41/221; F02D 41/3082

(57) ABSTRACT

The present invention relates to a fuel system for a combustion engine, the fuel system comprising a low-pressure circuit comprising at least one fuel tank, at least one low-pressure fuel pump, a first fuel filter and a second fuel filter which is arranged downstream of the first fuel pump, and a high-pressure circuit comprising a high-pressure fuel pump. The high-pressure fuel pump comprises means to suck fuel from the low-pressure circuit and in case of failure in the at least one low-pressure fuel pump, to suck fuel from the low-pressure circuit and the fuel is arranged to by-pass the at least one low-pressure fuel pump and optionally, at least one of the first or second fuel filters, via at least one by-pass pipe comprising a check valve that prevents the flow of fuel back to the fuel tank.

### CROSS-REFERENCE TO RELATED APPLICATIONS

This application is a national stage application (filed under 35 § U.S.C. 371) of PCT/SE2017/050787, filed Jul. 17, 2017 of the same title, which, in turn, claims priority to Swedish Application No. 1651070-3 filed Jul. 18, 2016; the contents of each of which are hereby incorporated by reference.

### FIELD OF THE INVENTION

The present invention relates to a fuel system for an internal combustion engine. The invention also relates to an internal combustion engine and a vehicle according to the appended claims.

### BACKGROUND OF THE INVENTION

An internal combustion engine, such as a diesel engine or an Otto engine, is equipped with a fuel system to transport fuel from one or several fuel tanks to the internal combustion engine's injection system. The fuel system comprises one or several fuel pumps, which may be driven mechanically by the internal combustion engine, or be driven by an electric engine. The fuel pumps create a fuel flow and pressure to transport the fuel to the internal combustion engine's injection system, which supplies the fuel to the internal combustion engine's combustion chamber.

The fuel systems may comprise only one mechanically driven or electrically driven fuel pump. The mechanically driven fuel pump is driven and controlled by the internal combustion engine and such pumps are robust and reliable in running, but may lead to increased fuel consumption and are difficult to control. Fuel pumps driven by an electric motor can be controlled by a control system of the vehicle, are not dependent on the operation of the internal combustion engine and can be arranged energy efficient and thus it is possible to reduce fuel consumption. However, if the only one fuel pump fails or provides too low fuel flow, the fuel supply to the internal combustion engine ceases and the internal combustion engine stops. There is a risk that the vehicle may suddenly come to a standstill on or along a road, and therefore it is desirable that the fuel system comprises some type of redundancy, so that the vehicle may be moved with the help of the internal combustion engine. With a so-called limp home function the vehicle may in this manner be moved and transported to the nearest service location.

To provided redundancy in the fuel system, US2003/0183205 discloses a fuel control system for controlling the supply of fuel to an engine comprising: pump means for providing a flow of fuel to said engine; first and second drive means for driving said pump means; and, control means for controlling said first and second drive means; wherein, said control means is arranged to control said first and second drive means such that in the event of failure of one of said first and second drive means, said pump means is driven by the other of said first and second drive means. However, the document does not suggest any solution on how to supply fuel to the engine in case of failure of both drive means.

DE10130352 shows another example of a solution in which the fuel injection system has a high pressure fuel pump, a first low pressure pump mechanically driven by the high pressure pump or the engine, for feeding fuel from a fuel tank to the suction side of the high pressure pump and a second electrically driven low pressure pump that is connected on the output side to the suction side of the first low pressure pump. The first low pressure fuel pump can supply fuel from the tank if the second low pressure pump is not in operation. However, the document does not suggest any solution on how to supply fuel to the engine in case of failure of both low pressure pumps.

Thus, even though there are prior art solutions for providing redundancy in fuel systems, there is still a desire to improve and simplify redundancy in fuel systems.

### SUMMARY OF THE INVENTION

There is thus a great desire to provide a fuel system for an internal combustion engine which reduces the risk of insufficient or non-existing fuel supply to the internal combustion engine in the event of an operational disturbance. Also it would be desirable to achieve a fuel system for an internal combustion engine which allows for simple control in case of operational disturbances and enables the driver of a vehicle to move the vehicle and drive it to a garage in the event of an operational disturbance. Another objective is to achieve a fuel system that is simple and non-bulky.

A further objective of the present invention is to provide a fuel system including redundancy by means of minimal amount of components while redundancy can be provided in a reliable way.

These objectives are achieved with a fuel system as specified in the appended claims.

Similar objectives are also achieved with an internal combustion engine and a vehicle with such a fuel system and a method for operating the fuel system.

The fuel system for an internal combustion engine comprises a low-pressure circuit comprising at least one fuel tank, at least one low-pressure fuel pump, a first fuel filter and a second fuel filter arranged downstream of the first fuel pump, and a high-pressure circuit comprising a high-pressure fuel pump. The high-pressure fuel pump comprises means to suck fuel from the low-pressure circuit, and in case of failure in any of the at least one low-pressure fuel pumps, the high-pressure fuel pump is arranged to suck fuel from the low-pressure circuit and the fuel is arranged to by-pass the at least one low-pressure fuel pump and optionally at least one of the first or second fuel filters via at least one by-pass pipe comprising a check valve that prevents the flow of fuel back to the fuel tank. In this way a simple and robust limp home function for a vehicle is provided and in this manner a vehicle may be moved and transported to the nearest service location.

The fuel system may be arranged with a common by-pass pipe with a check valve that prevents the flow of fuel back to the fuel tank. The by-pass pipe is arranged to by-pass the at least one low-pressure fuel pump and the at least one of the first or second fuel filters. In this way a simple structure for the pipe couplings may be provided.

Both the first fuel filter and the second fuel filter may be located downstream of the at least one low pressure fuel pump. In this way a simple by-pass construction may be provided for both filters and a decreased suction force for the high pressure fuel pump is needed in case of operational disturbances and in case both of the filters are by-passed. During the normal operation of the system, reduced suction force is required for the low-pressure fuel pump.

The first fuel filter may be arranged upstream of the at least one low-pressure fuel pump and the second fuel filter may be arranged downstream of the at least one low-pressure fuel pump. In this way the low pressure fuel pump is provided with a cleaner fuel and thus the operational age of the low pressure fuel pump may be increased.

The fuel may be arranged to by-pass the defect low-pressure fuel pump and the first fuel filter via a by-pass pipe comprising a check valve. The check valve prevents the flow of fuel back to the fuel tank. In this way filtration can be provided by the second fuel filter while the suction force of the high pressure fuel pump can be decreased.

Alternatively, the fuel may be arranged to pass through both the first and second fuel filters, and wherein a check valve is arranged between the first and second fuel filters to prevent the flow of fuel from the second fuel filter back to the first fuel filter. In this way clean fuel can be provided to the high pressure circuit.

In a variant of the invention, the fuel system may comprise a first low pressure fuel pump located upstream of a second low-pressure fuel pump and a second fuel tank, and wherein in case of failure in at least one of the low-pressure fuel pumps, both low-pressure fuel pumps are arranged to be turned off and the fuel is arranged to by-pass both low-pressure fuel pumps via at least one by-pass pipe comprising a check valve. The check valve prevents the flow of fuel back to any one of the fuel tanks. In this way the suction force of the high pressure fuel pump can be decreased.

Both the first and the second fuel filters can be located downstream of the first low pressure fuel pump and wherein the first fuel filter can be located upstream of the second fuel pump and the second fuel filter can be located downstream of the second fuel pump. In this way a lower suction force is required by the first fuel pump during normal operation of the system. Also, a simple construction for the by-pass pipes may be provided.

The fuel may be arranged to by-pass the first and second low-pressure fuel pumps and the first fuel filter via a common by-pass pipe comprising a check valve. In this way pressure can be built up in the fuel system and thus the suction force required by the high pressure pump may be kept low, even when the fuel is filtered through the second filter.

The fuel can be arranged to by-pass the first low-pressure pump and the second low-pressure fuel pump via a respective by-pass pipe. A check valve can be arranged downstream of the first fuel filter and upstream of the second filter. The check valve prevents the flow of fuel back to the fuel tank. Also in this way pressure can be built up in the fuel system.

Suitably, the means to suck fuel from the low-pressure circuit comprises at least one electrically controllable inlet valve. In this way, the valve can be controlled in a pre-determined way, e.g. by a control system of the vehicle.

Suitably, the high-pressure fuel pump comprises at least one electrically controllable inlet valve, wherein the inlet valve is arranged in an open position and the high pressure pump is arranged to suck fuel from the low-pressure circuit when the pressure of the fuel flow is lower than the pressure of the fuel flow during a normal operation of the internal combustion engine. Thus, the inlet valve may be actively controlled to open and the high pressure pump arranged to suck fuel and thus provide redundancy in a reliable and simple way. In this way it can be assured that fuel can be supplied to the high pressure fuel pump.

The present invention also relates to an internal combustion engine comprising the fuel system above. Further, the present invention relates to a vehicle comprising the internal combustion engine.

The invention further relates to a method of operating the fuel system above comprising the steps of:
identifying the functionality of the at least one low-pressure pump in the fuel system,
in the event of good functionality of the at least one low pressure fuel pump, the at least one low pressure fuel pump is arranged to supply fuel from the at least one fuel tank to the high pressure circuit by operating the at least one low pressure fuel pump with an electric motor, or
in the event of an identified operational disturbance in the at least one low pressure fuel pump:
optionally indicating to the driver that an operational disturbance has been identified,
turning off all low pressure fuel pumps,
arranging the flow of fuel to by-pass all low-pressure fuel pumps and optionally at least one of the first or second fuel filters via a by-pass pipe comprising a check valve that prevents the flow of fuel back to the at least one fuel tank,
opening an electrically controllable inlet valve of the high pressure pump and operating the high pressure pump to suck fuel upstream of the high pressure pump.

Further features and advantages will be apparent from the following detailed description.

### BRIEF DESCRIPTION OF THE DRAWINGS

FIG. 1 shows a schematic side view of a vehicle comprising a fuel system for an internal combustion engine according to the present invention,

FIG. 2 shows a coupling diagram for a fuel system according to an embodiment of the present invention, which comprises one low pressure fuel pump and a first filter downstream of the fuel pump,

FIG. 3 shows a coupling diagram for a fuel system according to an embodiment of the present invention, which comprises one low pressure fuel pump and a first filter upstream of the fuel pump,

FIG. 4 shows a coupling diagram for a fuel system according to an embodiment of the present invention, which comprises one low pressure fuel pump and a first filter downstream of the first fuel pump,

FIG. 5 shows a coupling diagram for a fuel system according to an embodiment of the present invention, which comprises two low pressure fuel pumps and a first filter downstream of the first fuel pump, and

FIG. 6 shows a coupling diagram for a fuel system according to an embodiment of the present invention, which comprises two low pressure fuel pumps and a first filter downstream of the first fuel pump.

### DETAILED DESCRIPTION OF THE INVENTION

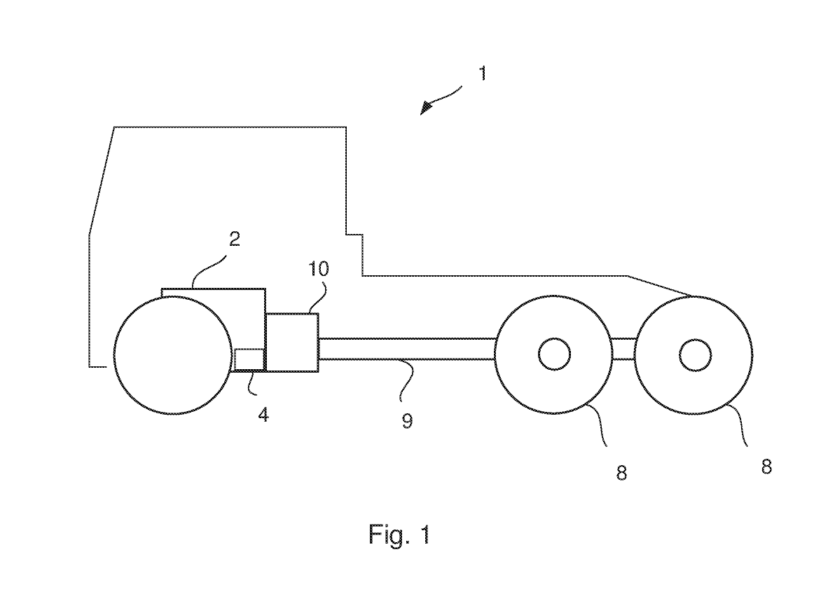

FIG. 1 schematically shows a side view of a vehicle 1 comprising a fuel system 4 according to the invention. The vehicle 1 comprises an internal combustion engine 2 connected to a gearbox 10. The gearbox 10 is also connected to the driving wheels 8 of the vehicle 1 through an output shaft of the gearbox (not shown). The vehicle also comprises a chassis 9. The vehicle 1 may be a heavy vehicle, e.g. a truck or a bus. The vehicle 1 may alternatively be a passenger car.

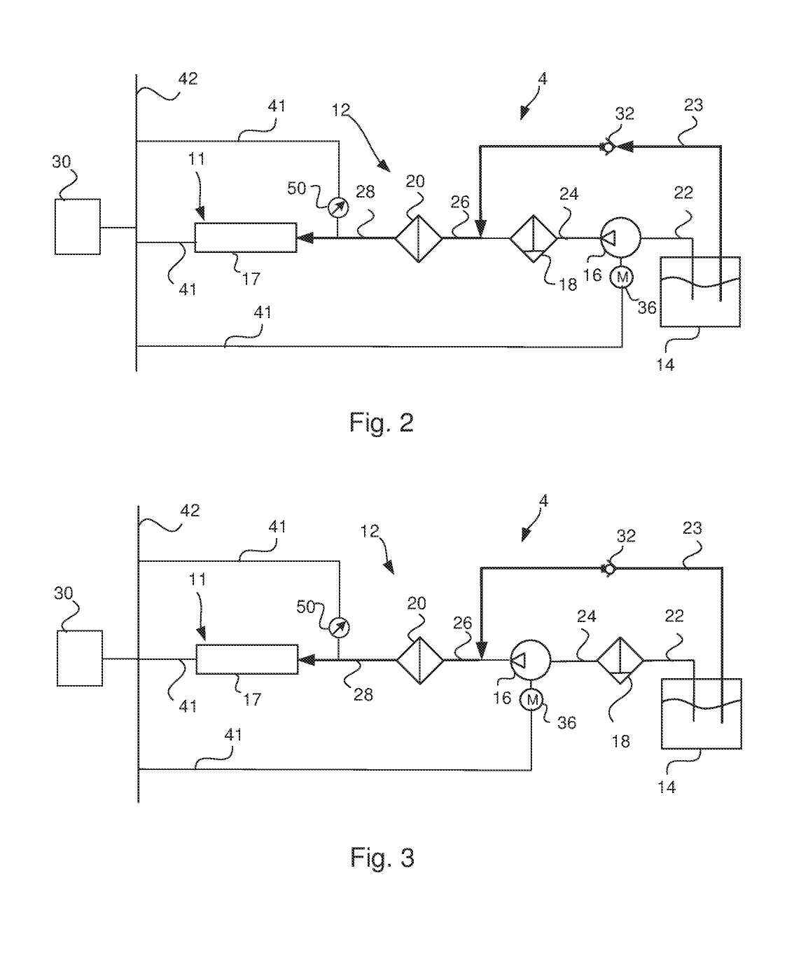

FIGS. 2 and 3 schematically show a coupling diagram for a fuel system 4 for an internal combustion engine 2 according to two embodiments of the present disclosure. The fuel system 4 comprises a low-pressure circuit 12 with a first fuel tank 14, a first fuel pump 16, a first fuel filter 18 arranged downstream of the first fuel pump 16 and a second fuel filter 20 arranged downstream of the first fuel filter 18. The first fuel pump 16 is driven by a first electric motor 36. The first fuel filter usable in the embodiments of the present invention is suitably a water-separating fuel filter. The fuel system 4 further comprises a high-pressure circuit 11 comprising a high-pressure fuel pump 17.

In FIG. 2 a first fuel pipe 22 is arranged in fluid connection with the first fuel tank 14 and the first fuel pump 16. A second fuel pipe 24 is arranged in fluid connection with the first fuel pump 16 and the first fuel filter 18. A third fuel pipe 26 is arranged in fluid connection with the first fuel filter 18 and the second fuel filter 20. A fourth fuel pipe 28 is arranged in fluid connection with the second fuel filter 20 and the high-pressure circuit 11 of the fuel system 4, which comprises a high pressure fuel pump 17. Thus, both the first fuel filter 18 and the second fuel filter 20 are located downstream of the low pressure fuel pump 16. Through this arrangement a decreased suction force is required by the low pressure pump 16 during normal operation of the fuel system. Also, when the filter is in the pressurized side rather than in the suction side, an improved water separation can be obtained through the life time of the filter.

In FIG. 3 a first fuel pipe 22 is arranged in fluid connection with the first fuel tank 14 and the first fuel filter 18. A second fuel pipe 24 is arranged in fluid connection with the first fuel filter 18 and the first fuel pump 16. A third fuel pipe 26 is arranged in fluid connection with the first fuel filter 18 and the second fuel filter 20. A fourth fuel pipe 28 is arranged in fluid connection with the second fuel filter 20 and a high-pressure circuit 11 of the fuel system 4, which comprises a high pressure fuel pump 17, similarly as in connection with the embodiment in FIG. 2. Thus, the embodiment of FIG. 3 differs from the embodiment in FIG. 2 in that the the first fuel filter is arranged upstream of the low-pressure fuel pump 16. By this arrangement during a normal operation of the fuel pump 16 a cleaner fuel can be supplied to the fuel pump 16.

The high pressure circuit usually comprises several other components, which are not displayed in detail, such as an accumulator in the form of a so-called common rail and an injection system, e.g. a unit injection system. Alternatively, common rail may be replaced e.g. by piezo-injection system.

During a normal operation of the fuel system as illustrated in FIG. 2, the first fuel pump 16 sucks fuel from the fuel tank 14 via the first fuel pipe 22 and supplies the fuel to the first fuel filter 18 via the second fuel pipe 24. According to a variant, a bypass valve can be arranged to allow fuel to return upstream of the first fuel pump via a by-pass pipe arranged in fluid connection with the first fuel pipe and the second fuel pipe in case of too high flow pressure is subjected to the first fuel filter during the normal operation of the fuel pump. The bypass valve can be thus adapted to be controlled based on the supply pressure downstream of the first fuel pump. In this way, it can be ensured that fuel with sufficient, but not too high, supply pressure is provided downstream of the first fuel pump.

The fuel is supplied from the first fuel filter 18 further to the second fuel filter 20 via the third fuel pipe 26. The fuel is then supplied via the fourth fuel pipe 28 to the high pressure circuit 11 and to the high pressure fuel pump 17, which operates at a first, normal, operational mode.

The pressure of the fuel flow is measured by means of a pressure indicator 50. During the normal operation, the pressure should be from about 5-10 bar. However, in case of a failure in the first fuel pump 16, the pressure drops, and consequently there is a risk that the internal combustion engine 2 will not receive enough fuel and the engine 2 stops. The failure may be recognized by the pressure indicator 50, which sends a signal to a control system 30 via a communication line 41 and a communication bus 42 of the vehicle. The communication bus may be wireless or comprise communication wires. The control system 42 may compare the measured pressure value with reference values and create a failure commando in case of pressure drop. Alternatively, lack of electric current in the electric motor 36 could be detected by suitable means. This in turn may create a failure signal that is communicated to the control system 30 via a communication line 41 and the communication bus 42.

The high pressure fuel pump comprises means to suck fuel from the fuels system upstream of the high pressure fuel pump, e.g. from the first fuel tank. Suitably, the means to suck fuel upstream of the high pressure fuel pump comprises, or is in fluid connection with, at least one electrically controllable, i.e. active, inlet valve or valves. In this way, the valve can be controlled in a pre-determined way, e.g. by a control system of the vehicle.

Suitably, the at least one electrically controllable inlet valve is arranged in an open position at a pressure of fuel flow which is lower than the pressure of fuel flow during a normal operation of the internal combustion engine. Thus, when the inlet valves are controlled in an open position, the high pressure pump can be arranged to suck fuel and thus provide redundancy in a reliable and simple way. In this way it can be assured that fuel can be supplied to the high pressure circuit and the high pressure fuel pump.

The high-pressure fuel pump may be for example of a type described in WO2016/043642, but is not limited to this specific type. The high pressure fuel pump is preferably driven by the internal combustion engine, but could be driven by an electric motor.

Generally, the inlet valve is in an open position during a normal operation of the fuel system when the fuel pressure obtains a pre-determined level. The inlet valve of the high pressure fuel pump in the present disclosure can be arranged in an open position and thus the high pressure pump to suck fuel whereby the high pressure pump is in a suction mode, when the fuel pressure is lower than the pre-determined level during the normal operation of the vehicle. The inlet valve is suitably connected to the control system of the vehicle. The control system is adapted to create a commando to the inlet valve to open and the high pressure pump to suck fuel from the low-pressure circuit of the fuel-system at levels below the pre-determined level during the normal operation of the vehicle, for example in case of failure in the low-pressure fuel pump or pumps, if there are several low-pressure fuel pumps in the fuel system. To decrease the mechanical suction force required by the high pressure fuel pump to suck fuel from the low pressure circuit and the fuel tank of the fuel system, the fuel system according to the present invention is provided with check valves and by-pass pipes or conduits whereby it is possible to by-pass the low-pressure fuel pump or pumps and optionally at least one of the fuel filters in the fuel system. When the pumps and optionally at least one of the filters are by-passed, the force required for suction of fuel is decreased. Suitably, at least one of the filters is by-passed. The by-pass pipes comprise also a check valve that prevents the flow of fuel back to the fuel tank. In this way it is possible to maintain a certain pressure level in the fuel system.

Returning to FIGS. 2 and 3, when failure in the low pressure fuel pump 16 is detected, it is turned off. In FIGS. 2 and 3 it is illustrated that the high-pressure fuel pump 17 may be arranged to receive a commando from the control system 30 to arrange the electrically controllable inlet valve or valves in an open position and thus to suck fuel and the high pressure pump 17 is arranged to suck fuel upstream of the high pressure fuel pump 17 in the fuel system 4. At the same time, the fuel flow is arranged to by-pass the low-pressure fuel pump 16 and the first fuel filter 18 via a by-pass pipe 23 comprising a check valve 32 that prevents the flow of fuel back to the fuel tank 14. In FIG. 2 the first fuel filter is located downstream of the low pressure fuel pump and in FIG. 3 upstream of the fuel pump 16. The check valve 32 thus allows the flow of fuel towards the high pressure circuit 11, but not backwards towards the fuel tank 14. When both the first fuel filter 18 and the second fuel filter 20 are located downstream of the low pressure fuel pump 16, the by-pass pipe 23 with the check valve 32 can be commonly arranged to by-pass the low-pressure fuel pump 16 and the first fuel filter 18 in an easy way. By by-passing the low pressure fuel pump and the first filter, the suction force required by the high pressure fuel pump is decreased. In this way, a vehicle comprising the fuel system may be transported in a limp-home mode to the nearest service location.

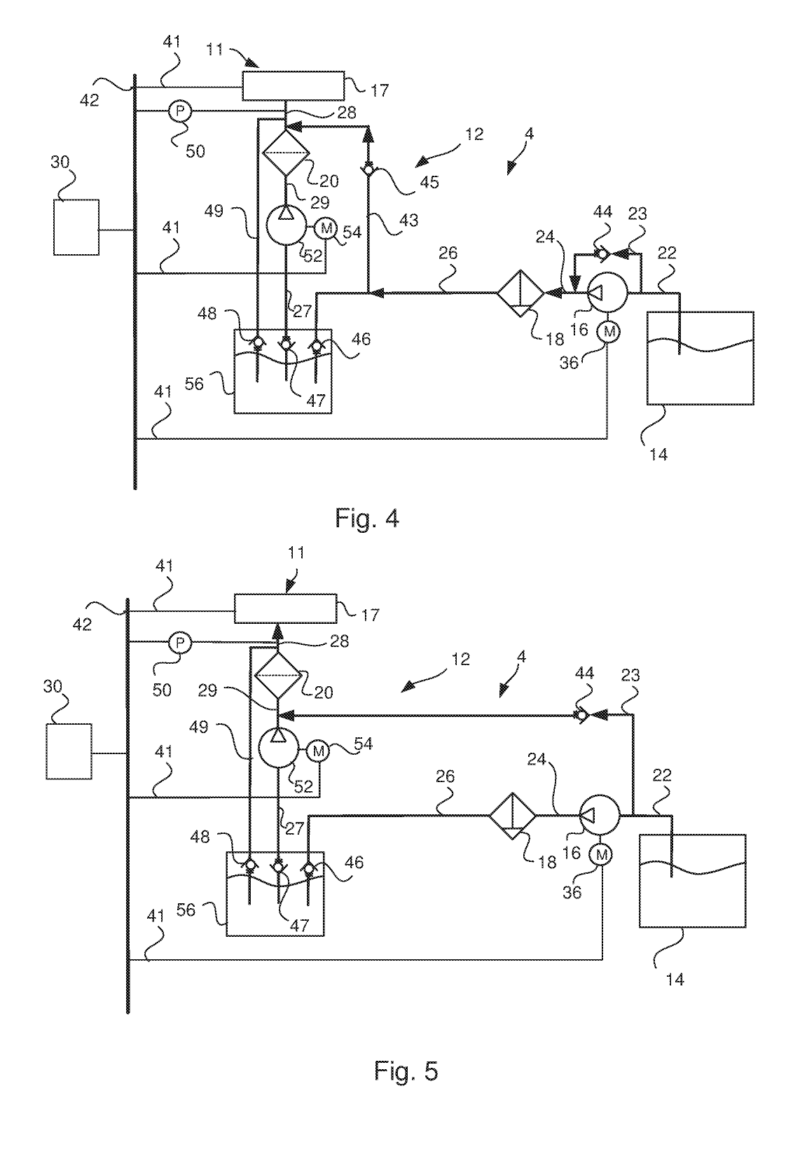

In FIGS. 4, 5 and 6 coupling diagrams for further embodiments of the present invention are shown. These embodiments differ from the embodiments shown in FIGS. 2 and 3 mainly in that the fuel systems comprise two fuel tanks 14 and 56 and two low pressure fuel pumps 16 and 52 operated by respective electric motors 36, 54. The fuel system 4 shown in FIG. 4-6 further comprises a low-pressure circuit 12 with a first fuel tank 14, a first fuel pump 16, which is also called a transfer pump, a first fuel filter 18 arranged downstream of the first fuel pump 16 and a second fuel filter 20 arranged downstream of the first fuel filter 18. The first fuel filter 18 is suitably a water-separating fuel filter. Downstream of the first filter a second fuel tank 56 is arranged. The second fuel 56 tank may be smaller than the first fuel tank. A second fuel pump 52 is arranged to suck fuel from the second fuel tank 56 and supply the fuel through the second fuel filter 20 to the high pressure circuit 11 comprising a high pressure fuel pump 17. In FIGS. 4, 5 and 6 the fuel system 4 can be coupled during the normal operation of the fuel pumps as follows. A first fuel pipe 22 is arranged in fluid connection with the first fuel tank 14 and the first fuel pump 16. A second fuel pipe 24 is arranged in fluid connection with the first fuel pump 16 and the first fuel filter 18. A third fuel pipe 26 is arranged in fluid connection with the first fuel filter 18 and the second fuel tank 56 and the third fuel pipe is arranged in fluid connection with a check valve 46 which prevents the fuel from being sucked back to the first fuel filter. A sixth fuel pipe 27 is arranged in fluid connection with the second fuel tank 56 and the second fuel pump 52, and a check valve 47 is arranged in fluid connection with the sixth fuel pipe 27 to prevent the fuel from flowing back to the second fuel tank 56. A fifth fuel pipe 29 is arranged between the second fuel pump and the second fuel filter 20. The fuel is then fed to the high-pressure circuit 11 of the fuel system 4 via a fourth fuel pipe 28, arranged between the second fuel filter 20 and the high pressure circuit 11, which comprises a high pressure fuel pump 17. Thus, both the first fuel filter 18 and the second fuel filter 20 are located downstream of the low pressure fuel pump 16. Through this arrangement a decreased suction force from the first fuel tank 14 is required by the low pressure pump 16 during normal operation of the fuel system. Also, when the filter is in the pressurized side rather than in the suction side, an improved water separation can be obtained through the life time of the filter. The fuel system 4 also comprises an overpressure protection pipe 49 comprising a check valve 48. In case the flow pressure to the high pressure circuit 11 is too high, as for example detected by the pressure sensor 50, an overflow of the fuel is returned back to the second fuel tank 56.

Returning to FIG. 4, when failure in the first low pressure fuel pump 16 and/or in the second low pressure fuel pump 52, is detected, both fuel pumps are turned off. The high-pressure fuel pump 17 is arranged to receive a commando from the control system 30 via the communication bus 42 and the communication line 41 in the same way as illustrated in connection with FIGS. 2 and 3, and thus the inlet valve/valves are arranged to open and the high pressure pump is arranged to suck fuel upstream of the high pressure fuel pump 17 in the fuel system 4 in a suitable way. At the same time, the fuel flow is arranged to by-pass the first low-pressure fuel pump 16 via a by-pass pipe 23 comprising a check valve 44 and the second fuel pump 52 and the second fuel filter 20 via a by-pass pipe 43 comprising a check valve 45. The flow direction during the failure is shown by arrows. The check valves 44 and 45 prevent the flow of fuel back to the fuel tank 14. The check valves 44 and 45 thus allow the flow of fuel towards the high pressure circuit 11, but not backwards towards the first fuel tank 14 and/or the second fuel tank 56. By by-passing the low pressure fuel pumps and the second fuel filter, the suction force required by the high pressure fuel pump is decreased. In this way, a vehicle comprising the fuel system may be transported in a limp-home mode to the nearest service location. The pressure required to open the check valve 48 in the overpressure protection pipe 49 is higher than the pressure required to open the check valve 45 in the by-pass line 43. In this way it can be prevented that the fuel sucked by the high pressure fuel pump 17 will be returned to the second fuel tank 56. Also the pressure required to open the check valve 47 in the sixth fuel pipe 27 and the pressure required to open the check valve 48 in the overpressure protection pipe 49 are higher than the sum of the pressure required to open both check valves 45 and 44. In this way it can be assured that fuel sucked by the high pressure fuel pump 17, when the inlet valve is in open position, will not leak back to the fuel system, and thus that a pressure can be built up in the fuel system 4. The pressure relation in the embodiment of FIG. 4 can be illustrated by the following formulas:

(p₄₄+p₄₅)<p₄₇≤p₄₈ (1)

p₄₅<p₄₈ (2)

Returning to FIG. 5, similarly as in connection with the embodiment of FIG. 4, when failure in the first low pressure fuel pump 16 and/or in the second low pressure fuel pump 56, is detected, both of the fuel pumps are turned off. The high-pressure fuel pump 17 may be arranged to receive a commando from the control system 30 via the communication bus 42 and the communication line 41 in the same way as illustrated in connection with FIGS. 2 and 3, and thus the inlet valve/valves are arranged to open and the high pressure pump is arranged to suck fuel upstream of the high pressure fuel pump 17 in the fuel system 4 in a suitable way, e.g. as described above. At the same time, the fuel flow is arranged to by-pass the first low-pressure fuel pump 16, the second low-pressure fuel pump 52 and the first fuel filter 18 via a by-pass pipe 23 comprising a check valve 44. The flow direction during the failure is shown by arrows. The check valve 44 prevents the flow of fuel back to the fuel tank 14. The check valve 44 allows the flow of fuel towards the high pressure circuit 11, but not backwards towards the first fuel tank 14. By by-passing the low pressure fuel pumps and the first fuel filter, the suction force required by the high pressure fuel pump is decreased. In this way, a vehicle comprising the fuel system may be transported in a limp-home mode to the nearest service location. Also in this embodiment, the pressure required to open the check valve 48 in the overpressure protection pipe 49 is higher than the pressure required to open the check valve 44 in the by-pass line 23. In this way it can be prevented that the fuel sucked by the high pressure fuel pump 17 will be returned to the first fuel tank 14. Also the pressure required to open the check valve 47 in the sixth fuel pipe 27 is higher than the pressure required to open the check valve 44. In this way it can be assured that fuel sucked by the high pressure fuel pump 17 will not leak back to the first fuel tank, and thus that a pressure can be built up in the fuel system 4. The pressure relation in the embodiment of FIG. 5 can be illustrated by the following formulas:

p₄₄<p₄₇≤p₄₈ (3)

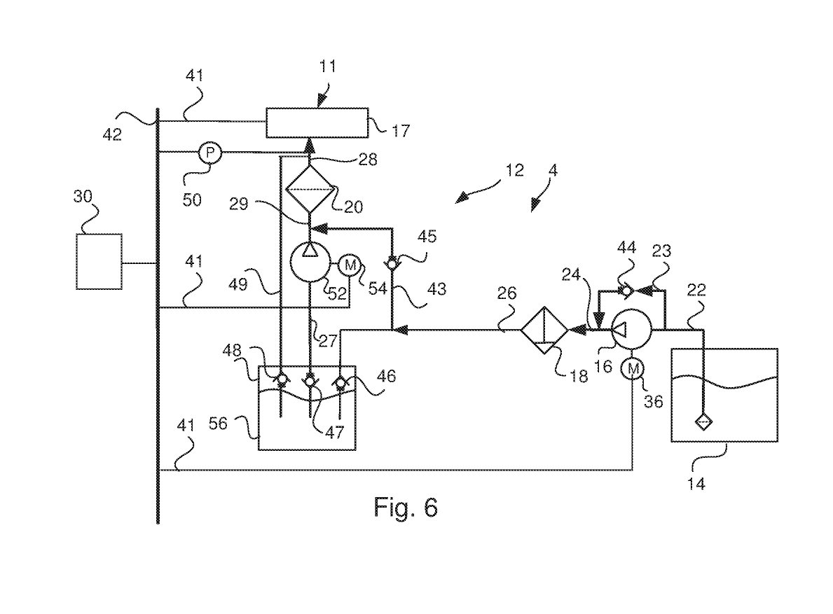

Returning to FIG. 6, similarly as in connection with the embodiments shown in FIGS. 4 and 5 when failure in the first low pressure fuel pump 16 and/or in the second low pressure fuel pump 52 is detected, both of the fuel pumps are turned off. The high-pressure fuel pump 17 may be arranged to receive a commando from the control system 30 via the communication line 41 and the communication bus 42 in the same way as illustrated in connection with FIGS. 2 and 3, and thus the inlet valve/valves are arranged to open and the high pressure pump is arranged to suck fuel upstream of the high pressure fuel pump 17 in the fuel system 4 in a suitable way, e.g. as described above. At the same time, the fuel flow is arranged to by-pass the first low-pressure fuel pump 16 via a by-pass pipe 23 comprising a check valve 44 and the second fuel pump 52 via a by-pass pipe 43 comprising a check valve 45. The flow direction during the failure is shown by arrows. The check valves 44 and 45 prevent the flow of fuel back to the first fuel tank 14. The check valves 44 and 45 thus allow the flow of fuel towards the high pressure circuit 11, but not backwards towards the first fuel tank 14. By by-passing both low pressure fuel pumps, the suction force required by the high pressure fuel pump is decreased. However, since the fuel is arranged to flow through both fuel filters, the quality of the fuel can be kept high while somewhat higher suction performance is required by the high pressure fuel pump. In this way, a vehicle comprising the fuel system may be transported in a limp-home mode to the nearest service location. The pressure required to open the check valve 48 in the overpressure protection pipe 49 is higher than the pressure required to open the check valve 45 in the by-pass line 43. In this way it can be prevented that the fuel sucked by the high pressure fuel pump 17 will be returned to the first fuel tank 14. Also the pressure required to open the check valve 47 in the sixth fuel pipe 27 and the pressure required to open the check valve 48 in the overpressure protection pipe 49 are higher than the sum of the pressure required to open both check valves 45 and 44. In this way it can be assured that fuel sucked by the high pressure fuel pump 17 will not leak back to the fuel system, and thus that a pressure can be built up in the fuel system 4. The pressure relation in the embodiment of FIG. 4 can be illustrated by the following formulas:

(p₄₄+p₄₅)<p₄₇≤p₄₈ (1)

p₄₅<p₄₈ (2)

The fuel system 4 may comprise components not shown in the figure according to common fuel systems. The fuel system may be operated according to a following method which comprises the steps of:
identifying the functionality of the at least one low-pressure pump in the fuel system,
in the event of good functionality of the at least one low pressure fuel pump, the at least one low pressure fuel pump is arranged to supply fuel from the at least one fuel tank to the high pressure circuit by operating the at least one low pressure fuel pump with an electric motor, or
in the event of an identified operational disturbance in the at least one low pressure fuel pump:
optionally indicating to the driver that an operational disturbance has been identified,
turning off all low pressure fuel pumps,
arranging the flow of fuel to by-pass all low-pressure fuel pumps and optionally at least one of the first or second fuel filters via a by-pass pipe comprising a check valve that prevents the flow of fuel back to the fuel tank,
opening an electrically controllable inlet valve of the high pressure pump and operating the high pressure pump to suck fuel upstream of the high pressure fuel pump.

Indication of an identified operational disturbance may, in a further developed embodiment, comprise an indication to the driver of the available driving distance that a vehicle may be driven. In such a case, the method may comprise a step for the calculation of an available driving distance, based on the known fuel consumption. Analogously, in an internal combustion engine that is used in other applications, a remaining operating time for the internal combustion engine, when driven with an indicated operational disturbance, may be presented. In such a case, the method may comprise a step for the calculation of a remaining operating time.

In a further developed embodiment, in the event of an indication of an identified operational disturbance, the method may comprise a step which reduces the engine's fuel consumption by initiating a shut-off of certain attachments driven by the engine, e.g. a compressor for air conditioning.

The components and features specified above may, within the framework of the invention, be combined between different embodiments specified.

1. A fuel system for an internal combustion engine, the fuel system comprising:
a low-pressure circuit comprising at least one fuel tank;
at least one low-pressure fuel pump;
a first fuel filter and a second fuel filter which is arranged downstream of the first fuel pump; and
a high-pressure circuit comprising a high-pressure fuel pump, wherein the high-pressure fuel pump comprises:
means to suck fuel from the low-pressure circuit, and in case of failure in any of the at least one low-pressure fuel pumps, the high-pressure fuel pump is arranged to suck fuel from the low-pressure circuit and the fuel is arranged to by-pass the at least one low-pressure fuel pump via at least one by-pass pipe comprising a check valve that prevents the flow of fuel back to the fuel tank.

2. The fuel system according to claim 1, further comprising a common by-pass pipe with a check valve that prevents the flow of fuel back to the fuel tank is arranged to by-pass the at least one low-pressure fuel pump and at least one of the first or second fuel filters.

3. The fuel system according to claim 1, wherein both the first fuel filter and the second fuel filter are located downstream of the at least one low pressure fuel pump.

4. The fuel system according to claim 1, wherein the first fuel filter is arranged upstream of the at least one low-pressure fuel pump and the second fuel filter is arranged downstream of the at least one low-pressure fuel pump.

5. The fuel system according to claim 3, wherein fuel is arranged to by-pass both the defect low-pressure fuel pump and the first fuel filter via a by-pass pipe comprising a check valve, which check valve prevents the flow of fuel back to the fuel tank.

6. The fuel system according to claim 1, wherein the fuel is arranged to pass through both the first and second fuel filters, and wherein a check valve is arranged between the first and second fuel filters to prevent the flow of fuel from the second fuel filter back to the first fuel filter.

7. The fuel system according to claim 1, wherein the fuel system comprises a first low pressure fuel pump located upstream of a second low-pressure fuel pump and a second fuel tank, and wherein, in case of failure in at least one of the low-pressure fuel pumps, both low-pressure fuel pumps are arranged to be turned off and the fuel is arranged to by-pass both low-pressure fuel pumps via at least one by-pass pipe comprising a check valve, which check valve prevents the flow of fuel back to any one of the fuel tanks.

8. The fuel system according to claim 7, wherein both the first and the second fuel filters are located downstream of the first low pressure fuel pump and wherein the first fuel filter is located upstream of the second fuel pump and the second fuel filter is located downstream of the second fuel pump.

9. The fuel system according to claim 7, wherein the fuel is arranged to by-pass the first and second low-pressure fuel pumps and the first fuel filter via a common by-pass pipe comprising a check valve.

10. The fuel system according to claim 7, wherein the fuel is arranged to by-pass the first low-pressure pump and the second low-pressure fuel pump via a respective by-pass pipe, wherein a check valve is arranged downstream of the first fuel filter and upstream of the second filter, which check valve prevents the flow of fuel back to the fuel tanks.

11. The fuel system according to claim 1, wherein the means to suck fuel from the low-pressure circuit comprises at least one electrically controllable inlet valve.

12. The fuel system according to claim 12, wherein the high-pressure fuel pump comprises at least one electrically controllable inlet valve, wherein the inlet valve is arranged in an open position and the high pressure pump is arranged to suck fuel from the low-pressure circuit when the pressure of the fuel flow is lower than the pressure of the fuel flow during a normal operation of the internal combustion engine.

13. The fuel system according to claim 1, wherein in the high pressure fuel pump is driven by the internal combustion engine.

14. An internal combustion engine comprising a fuel system, in turn, comprising:
a low-pressure circuit comprising at least one fuel tank;
at least one low-pressure fuel pump;
a first fuel filter and a second fuel filter which is arranged downstream of the first fuel pump; and
a high-pressure circuit comprising a high-pressure fuel pump, wherein the high-pressure fuel pump comprises:
means to suck fuel from the low-pressure circuit, and in case of failure in any of the at least one low-pressure fuel pumps, the high-pressure fuel pump is arranged to suck fuel from the low-pressure circuit and the fuel is arranged to by-pass the at least one low-pressure fuel pump via at least one by-pass pipe comprising a check valve that prevents the flow of fuel back to the fuel tank.

15. A vehicle comprising:
an internal combustion engine; and
a fuel system, in turn, comprising:
a low-pressure circuit comprising at least one fuel tank;
at least one low-pressure fuel pump;
a first fuel filter and a second fuel filter which is arranged downstream of the first fuel pump; and
a high-pressure circuit comprising a high-pressure fuel pump, wherein the high-pressure fuel pump comprises:
means to suck fuel from the low-pressure circuit, and in case of failure in any of the at least one low-pressure fuel pumps, the high-pressure fuel pump is arranged to suck fuel from the low-pressure circuit and the fuel is arranged to by-pass the at least one low-pressure fuel pump via at least one by-pass pipe comprising a check valve that prevents the flow of fuel back to the fuel tank.

16. A method of operating the fuel system comprising: a low-pressure circuit comprising at least one fuel tank; at least one low-pressure fuel pump; a first fuel filter and a second fuel filter which is arranged downstream of the first fuel pump; and a high-pressure circuit comprising a high-pressure fuel pump, wherein said method comprises:
identifying the functionality of the at least one low-pressure pump in the fuel system;
in the event of good functionality of the at least one low pressure fuel pump, the at least one low pressure fuel pump is arranged to supply fuel from the at least one fuel tank to the high pressure circuit by operating the at least one low pressure fuel pump with an electric motor; or
in the event of an identified operational disturbance in the at least one low pressure fuel pump:
turning off all low pressure fuel pumps;
arranging the flow of fuel to by-pass the at least one low-pressure fuel pump via a by-pass pipe comprising a check valve that prevents the flow of fuel back to the at least one fuel tank;
opening an electrically controllable inlet valve of the high pressure pump; and
operating the high pressure pump to suck fuel upstream of the high pressure pump.

17. The fuel system according to claim 1, wherein said means to suck fuel from the low-pressure circuit is arranged to suck fuel from the low-pressure circuit and the fuel is arranged to by-pass the at least one low-pressure fuel pump and at least one of the first or second fuel filters via the at least one by-pass pipe comprising the check valve that prevents the flow of fuel back to the fuel tank.

18. The internal combustion engine according to claim 14, wherein said means to suck fuel from the low-pressure circuit is arranged to suck fuel from the low-pressure circuit and the fuel is arranged to by-pass the at least one low-pressure fuel pump and at least one of the first or second fuel filters via the at least one by-pass pipe comprising the check valve that prevents the flow of fuel back to the fuel tank.

19. The vehicle according to claim 15, wherein said means to suck fuel from the low-pressure circuit is arranged to suck fuel from the low-pressure circuit and the fuel is arranged to by-pass the at least one low-pressure fuel pump and at least one of the first or second fuel filters via the at least one by-pass pipe comprising the check valve that prevents the flow of fuel back to the fuel tank.

20. The method according to claim 16, wherein said arranging the flow of fuel comprising arranging the flow of fuel to by-pass the at least one low-pressure fuel pump and at least one of the first or second fuel filters via the by-pass pipe comprising the check valve that prevents the flow of fuel back to the at least one fuel tank.
